(19) United States
(12) Patent Application Publication
(10) Pub. No.: US 2022/0012818 A1
(43) Pub. Date: Jan. 13, 2022

(54) MYCOUNTRY MYWORLD SOCIAL MEDIA REWARDS SYSTEM

(71) Applicants: Samuel G. ZEAN, North Brooklyn Park, MN (US); Eunice K. ZEAN, North Brooklyn Park, MN (US)

(72) Inventors: Samuel G. ZEAN, North Brooklyn Park, MN (US); Eunice K. ZEAN, North Brooklyn Park, MN (US)

(21) Appl. No.: 16/941,479

(22) Filed: Jul. 28, 2020

Related U.S. Application Data
(60) Provisional application No. 63/102,913, filed on Jul. 8, 2020.

(51) Int. Cl. G06Q 50/00; G06Q 30/02; G06Q 30/06; G06Q 10/10; G06Q 20/38; G06F 16/28; G06F 16/9535; G06F 16/9536; H04L 12/58; H04L 29/08

(52) U.S. Cl. CPC G06Q 50/01; G06Q 2230/00; G06Q 30/0276; G06Q 30/0239; G06Q 30/0641; G06Q 10/10; G06Q 30/0215; G06Q 30/0273; G06Q 30/0633; G06Q 30/0611; G06Q 30/0625; G06Q 30/0222; G06Q 20/384; G06Q 30/0218; G06Q 30/0205; G06Q 30/0282; G06F 16/285; G06F 16/9535; G06F 16/9536; H04L 51/32; H04L 67/306; H04L 51/20; G06Q 30/0277

(57) ABSTRACT

A system and method for providing awards and rewards to social media users for the content/posts they upload to their social media profiles is disclosed. The system uses a content management manager for creating, managing, and displaying a user timeline for each of the social media users, an ad insertion engine for creating, managing, and inserting ads into the user timeline for each of the social media users, an awards manager for awarding each of the social media users rewards in exchange for watching ads before viewing content, and a marketsquare manager for creating, managing, and displaying items for sale in an online marketplace in which each of the social media users may be buyers and seller.

### CROSS-REFERENCE TO RELATED APPLICATIONS

This application claims priority to U.S. Provisional Patent Application No. 63/102,913, titled “MYCOUNTRYMYWORLD SOCIAL MEDIA REWARDS SYSTEM,” and filed on Jul. 8, 2020. The entire application is incorporated herein by reference in its entirety.

### TECHNICAL FIELD

This application relates in general to a system and method for providing a social media platform, and more specifically, to a system and method for providing awards and rewards to social media users for the contents/posts they upload to their social media profiles/news feeds.

### BACKGROUND

Social media websites/apps provide platforms for interaction between users. Current social media trends and platforms include sites/apps such as Facebook™, Twitter™, YouTube™, Instagram™, TikTok™, and Linkedin™, to name just a few. Current social media platforms are fragmented with each social media platform offering one or more features not offered by other platforms. For example, a social network such as Linkedin™ is directed toward business connections and promoting business interactions, whereas a social network such as TikTok™ captures short-form mobile video meant to creatively showcase moments in life. YouTube™ allows users to upload, view, review/rate, and share video content, and subscribe to other users' content. Twitter™ is a microblogging and social networking service on which users post and interact with very brief messages known as “tweets,” including the uploads of short message videos. Instagram™ is a photo- and video-sharing social networking service owned by Facebook, Inc. And finally, Facebook™ is one of the world's largest social networking site, with millions of personal, business, and artists' profiles.

All of these apps/sites can be accessed from devices all over the world with Internet connectivity, such as personal computers, tablets, and smartphones. After registering, users can create a customized profile revealing information about themselves. They can post text, photos and multimedia which is shared with any other user that has agreed to be connected, or with a different privacy setting, with any viewer. Users can also use various embedded apps, join common-interest groups, buy, and sell items or services on marketplaces, and receive notifications of friends' activities and the activities of profiles/pages of interest. Although each platform mentioned above has striking similarities in functionalities, they each hold separate patents on their principle inventive concepts.

None of the platforms mentioned, however, employs any inventive concept or method that inspires users' engagements or that fosters users' creativities, passions, competitiveness, and strong desires to conceive and create captivating uploads that are designed to be more appealing and successful than fellow users on the platforms. They do not have any element that conducts global creative contests with awards and rewards given to users, whether for uploading creative and talent-driven contents on such platform or employing a system or method that rewards users for buying on social media platforms.

Additionally, they do not employ any inventive concept or method that automatically assign credits or accreditations to users for their contents that they upload on such platforms so that a post when uploaded can display a user's name, city or state and the user's country of origin or resident. Further, none of these platforms employ any inventive concept or method that revolutionizes or creates any unique users' rating or judging system or method that can rank users (by their contents) according to the ratings or votes their posts/contents received from other users, nor have such platforms employed any inventive creative concept consisting of color-coded timer system that automatically changes the colors of users' posts/contents upon upload to signal different color-coded stages of users' posts/contents on such platforms, designed to automatically and continuously alert and aid users in discerning the stages of their contents in the news feeds on such platforms. Competitions and contests that cross international borders and involve various countries such as the World Soccer Cup, the International Olympics, elite cycling events such as the Tour de France, Tour de Suisse, and Tour Down Under, the Iditarod Trail Sled Dog Race, and world track & field events have viewership levels that are often exceptional, unparalleled, or unmatched.

Therefore, a need exists for an online data sharing mechanism that creates a world model via social media platforms for recognizing, awarding, and rewarding users through global contents showcasing competitions. These competitions will incentivize and foster the creation of captivating and entertaining content that attracts a continuous global flow of traffic across platforms. Systems models, or methods that award and reward social media users for their uploaded content may be useful to the platforms for generating massive, record-breaking traffic, for generating increased advertising revenues, and for making social media users voluntarily view, watch, and rate web and social media ads.

If a social media platform incentivizes users' participation by awarding and rewarding users in an inventive way, there will be steady, unprecedented global traffic that would result in increased ad revenue. By rewarding users through talent-driven contents, the artistic level of content increases and the entertainment propels views, likes, shares, and userships. The present invention attempts to address the limitations of existing social media platforms according to the principles disclosed herein.

### SUMMARY

The above and other problems are solved by providing a system and method for providing a social media platform, and more specifically, to a system and method for providing awards and rewards to social media users for the content/posts they upload to their social media profiles, in a group or an event, where contents/posts will also appear in other users' News Feeds or on the platform's News Feed according to the principles and example embodiments disclosed herein. In the awards and/or rewards for users, the users that reach the platform require milestones, and finalists (including the eventual winners) are selected through a combination of ratings and/or votes by platform's general users from one feed to another by the platforms' global users. The present invention employs a method or model to award honors to the most effective and innovative social talent-driven posts and contents, encourage and accelerate users' engagement, increase traffic by competition and create intense excitement and entertain. The selection of best contents, finalists, or eventual winners includes but are not limited to one or a combination of methods.

According to one aspect of the invention, a system and method for providing a social medial content viewing, liking, and sharing platform, technology that apply the typical elements of game playing in one feed, and competition in another by employing online marketing techniques to gamify users' engagements and interactions on the platform for the purpose of inspiring talent-driven contents or posts, fostering unprecedented users traffics and encouraging an unmatched engagement by users in a competitive, rewarding and gamify fashion. The application introduces multiple new inventive concepts and breakthrough features and functionalities on a social media platform designed to revolutionize the way social media users upload contents, view contents, share contents and rate contents.

In one embodiment, the present invention is a system for providing awards and rewards to social media users for the content/posts they upload to their social media profiles. The system uses a content management manager for creating, managing, and displaying a user timeline for each of the social media users, an ad insertion engine for creating, managing, and inserting ads into the user timeline for each of the social media users, an awards manager for awarding each of the social media users rewards in exchange for watching ads before viewing content. and a market square manager for creating, managing, and displaying items for sale in an online marketplace in which each of the social media users may be buyers and seller.

In another embodiment the present invention is a system for providing an inventive concept in employing a function or feature that enable users to click a button to vote for a post or content that a user chooses as their User's Choice of what they believe is the best post on the platform that deserves award and reward. The system uses a content management manager for creating, managing, and displaying posts or contents that are uploaded and posted on the platform to be positioned by their ranks or standing according to users' votes. Currently social media platforms or prior acts may only limit the ratings of a user's posts or contents to the amounts of “views” and “likes.” However, for the first time, the system or method employed will enable and allow users' rating of posts or contents on a social media platform to include the amounts of views, likes and shares, combined since “views” and “likes” alone do little to foster any extra traffics or users' engagements on social media platforms as opposed to the amount of “shares” which can cause posts or contents to trend/buzz that can result in more users across platforms to receive and view what is trending that was shared with them. Users that reaches certain milestones on all three (views, likes and shares) judging or rating criteria could be issued awards and/or rewards.

In another embodiment the present invention is a system for employing a function or feature that enable a color-coded feature of users' posts or contents that is modeled after the universal traffic lights system to be employed on a social media platform. The duration of each round of users' showcasing competition may run ever four months or so for a total of multiple competitions in a year to keep the platform fully engaged year-round. When a user uploads a content, the upload may post with a green color-coded display. Into two months or so into each competition or contest, which is halfway into the four months in a competition, the post or content will automatically change from one color to another and/or more specifically, from green to orange color. Immediately at the end of four months or prescribed duration, the post will change from one color to another and so forth, and/or more specifically from orange to a red color-coded display. Such changes are to serve as an alert that the competition or the duration of contents in the news has ended. As mentioned, the color-coded display system is modeled after the universal traffic light system, signaling that green is for go, orange is alerting users to be prepared to see that round of contents showcasing to end. Whereas, red is for alerting users that that round of contents showcasing has ended. Hence, the color-coded display feature is designed to serves as a universal timer or timing system for the platform's users' global competitions or contest although the use of this system is not limited to any one particular usage as described and may be used in multiple other ways whether imaginable or currently unknown.

In another embodiment, the present invention is a method for providing credits or accreditations to social media users for the content/posts they upload to their social media profiles or news feeds. Artists are credited for their work of arts with their names. However, social media platforms have not employed any method to credit social media users for their content/posts they upload to their social media profiles or news feeds. Even contents or a post that may be trending and causing buzz do not identify the user(sO that post such contents or post so that other users can see the post(s) at first glance and give that user(s) his due. myCountry myWorld has changed this by employing a method automatically accredit or assign credit to each content or post that a social media user uploads with a display of the user's name, city or state and country of birth or resident. Accreditations are to be ascribed to users even after the user's contents or post is shared by other users. In so doing such as an artist is globally recognized for his or her work of art even from centuries ago, so will social media users be globally recognized for their post or contents they uploaded on a social media platform.

In another embodiment, the present invention is a method for providing awards and rewards to social media users for the content/posts they upload to their social media profiles. The method logs a user into an online platform, views the user timeline containing a sequence of posted content, comments, items for sale, and ads associated with each of the social media users, the user timeline includes content showcasing competitions, selects a first posting from the user timeline for viewing, prompts the user to view an ad before viewing the first posting, when the user accepts the ad, show the user the ad before viewing the content in exchange for reward points, when the user declines the ad, show the user the content, when the user selects an item for sale from the user timeline, presents an item page associated with the item for sale, awards reward points to the user in response to content showcasing competition awards, and searches the platform for additional user timeline items for viewing. The platform includes a content management manager for creating, managing, and displaying a user timeline for each of the social media users, an ad insertion engine for creating, managing, and inserting ads into the user timeline for each of the social media users, an awards manager for awarding each of the social media users rewards in exchange for watching ads before viewing content, and a marketsquare manager for creating, managing, and displaying items for sale in an online marketplace in which each of the social media users may be buyers and seller.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system for providing awards and rewards to social media users for the content/posts they upload to their social media profiles according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3a-b illustrates an example embodiment of a user feed within a social media platform for providing awards and rewards to social media users for the content/posts they upload to their social media profiles according to the present invention.

FIG. 4a-b illustrates an example embodiment of a user post edit screen within a social media platform for providing awards and rewards to social media users for the content/posts they upload to their social media profiles according to the present invention.

FIG. 5 illustrates a MarketSquare marketplace for users to buy and sell merchandise to other users according to the present invention.

FIG. 6 illustrates a computing system of software components for providing awards and rewards to social media users for the content/posts they upload to their social media profiles according to the present invention.

FIG. 7 illustrates a flowchart corresponding to a method performed by software components for providing awards and rewards to social media users for the content/posts they upload to their social media profiles according to the present invention.

### DETAILED DESCRIPTION

This application relates in general to a system and method for providing a social media platform and more specifically, to a system and method for providing awards and rewards to social media users for the content/posts they upload to their social media profiles according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The term “mobile application” refers to an application executing on a mobile device such as a smartphone, tablet, and/or web browser on any computing device.

The terms “customer,” “client,” and “user” refer to an entity, e.g. a human, using the myCountry myWorld Social Media Rewards System, including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), ethernet cable(s) or wireless connection(s) using any type of frequency/frequencies or radio wave(s). Some examples are including below in this application.

The term “invention” or “present invention” refers to the invention being applied for via the patent application with the title “myCountry myWorld Social Media System.” Invention may be used interchangeably with social media rewards system.

The terms “communicate” or “communication” refer to any component(s) connecting with any other component(s) in any combination for the purpose of the connected components to communicate and/or transfer data to and from any components and/or control any settings,

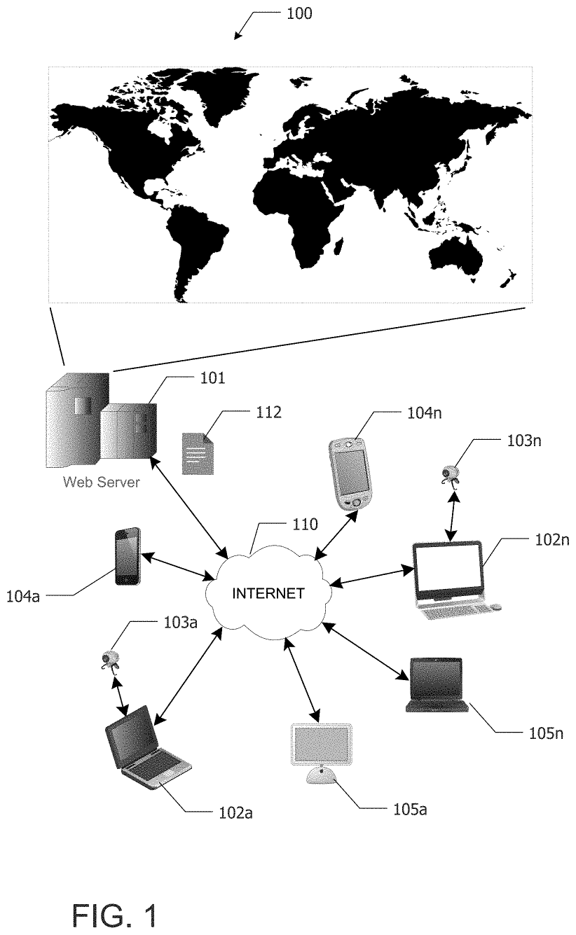

In general, the present disclosure relates a system and method for providing awards and rewards to social media users for the content/posts they upload to their social media profiles. To better understand the present invention, FIG. 1 illustrates an example embodiment for a system 100 for providing awards and rewards to social media users for the content/posts they upload to their social media profiles according to the present invention.

On the myCountry myWorld social media rewards system 100 is a web service hosted on a web server 101 having a feature or advertising archive that showcases creative adverts, coupons, discounts and savings from various companies and corporations around the world. This system 100 is designed as a medium to create incentives for and further reward social media platform's users. Additionally, the system 100 is designed to drive unprecedented traffic and create increased revenue and sponsorship revenue in the form of rewards that entice users to voluntarily view ads on the platform.

This social media rewards system 100 is bound to drive high user traffic that will affect the way advertisements are run. This system 101 will create an advertising archive and platform that enables the advertising community to showcase their creative adverts from around the world via a social media rewards system that attracts users and amasses traffic in what would be considered voluntary and willing views of such ads.

The web server 101 may be accessed by users 105a-n who are viewing content on the social media platform 100 and users 102a-n who are generating and uploading content that is viewable on their social media profiles 100. The users 102a-n who are generating and uploading content may utilize video capture devices 103a-n coupled to their computing systems 102a-n or that are built into their mobile devices 104a-n. Users may access the social media platform 100 on their computing devices 102a-n, 104a-n, 105a-n using a mobile or native application or using a web browser.

Once a user enters the page 112 of the advertising archive on the platform and clicks to play an ad, the user is either asked or presented with a trivia quiz at the end of the commercial or ad. The user is then required to watch a series of other ads to find or discover the answers at the end of those ads which could be words, pictures, matching diagram(s) or symbol(s). Think of this concept as matching games that require players to match similar elements. As the name implies, participants need to find a match for a word, picture, or card. In this instance, users must watch ads to hear what the trivia quiz is at the end of the ads to match words, pictures, cards, diagrams, and symbols to other ads they watched to find the answer or solve the puzzle.

Treasure Hunt and Treasure Hunt Clues: Treasure hunts are an excellent way to have fun, create users' engagements, interaction, and myCountry myWorld employs methods of free treasure hunt and treasure hunt clues to create more odds or option for users to earn reward from watching ads! myCountry myWorld's Treasure Hunt and Treasure Hunt Clues just like users' trivia questions, will appear at the end of each of each ad. A user must fully watch an ad to completion to be presented with a treasure hunt and clues. Treasure hunts and clauses are mixed up with challenges, codes, searches, and puzzles. Users may be presented with Jigsaw Puzzles where a user may have to listen intently to the clues or instructions. A written location of the clue may be shown or displayed to users and may be displayed cut up into random shapes to form a jigsaw puzzle. The pieces could be read or displayed to the Treasure Hunters or users all at once or separately in separate ads they may be instructed to watch. Users then must work out how they fit together to form the clue in the ads they may be instructed to watch. Such clues may work well with extensive clues—clues that are very descriptive more interesting in the users' experience solving the jigsaw puzzle. Story Map: Hunters/Users may be presented a (normally fictional) map with recognizable features, paths, and letters as clues to find answers. A set of instructions may be presented at the end of each ad that tells the users which paths to follow on the map. As they follow the paths, they are revealed the clues. Letter Grid: Hunters/Users may be presented or displayed sets grid of letters which may spell out clues if read in the correct order. The hunters/users must be told which order to move across the grid to read the clue. Examples may be presented that show the sequence the letters are read, but users could use compass points (North, South, East, West or N/S/E/W) or directions (Up, Down, Left, Right or U/D/L/R) etc. Treasures may be given to winners in the form of cash awards, coupons, gifts, discounts, sales, awards, and/or other such rewards.

Awards could vary in amounts and values and could include small to large cash awards, coupons awards, savings awards, gifts, vacation price reduction awards, and so forth. Users are awarded with the payments from the trivia quizzes or questions they solved. The first user who solves a quiz(s) and is the first to register or file for his/her reward(s) wins that prize(s). Every other user that follows is disqualified from receiving the award(s) or prize(s) on the same contest. Contests may be updated daily and may be randomly or sequentially run. Each user is required to rate the ad as liked or disliked. The advertising archive may contain and enable Corporate sponsors a platform to showcase their brands, products, and services where users can rate. The companies or corporations with the most or highest viewed and liked brands, products and services or ads will win awards of their own to be issued by the social media rewards system.

The process of incentivizing social media users to play the role of untraditional or unconventional paid advertising vehicles for corporations on a social media platform. Social sharing describes when social media users broadcast web content on a social network to their connections, groups, or specific individuals. One of the primary, aims of corporate social media marketing strategies is to generate brand awareness by leveraging their existing audience to share content. Unlike advertisements or other marketing assets, social shares is an organic form of promotion generated by the public. Consumers share products, blog posts, and inspirational images because they want to. When social connections—including friends, family, and coworkers—see shared content, it resonates more than a message displayed directly by a business. This fact highlights just how much more valuable social activity is over social media ads. Each time someone shares an article, link, or promotion it has the potential to domino into a wide network of potential customers. Once a post is shared, it is then seen by an entirely new audience that can further spread it throughout their own network. Posts created with the intent of gaining mass exposure through repetitive sharing is referred to a viral marketing. Beyond product recommendations and sales or promotions, social sharing is also a critical place to define a brand. Consumers do not only visit a company's web site to understand who they are and what they offer—they also go to their social media Page or Feed.

Social media gives businesses a chance to define what they stand for, what they are trying to achieve, and how it helps the community. Social media is much more interactive than a website. Seeing how a company engages with its customers is more substantive than simply making a website claim. Most importantly, when users share a company's posts or content, it validates them in the eyes of consumers. Social proof is invaluable for a business' reputation and has the tendency to increase exponentially when a foundation is established.

But why businesses and social media platforms' executives or owners benefit from users' social sharing, the users themselves never get even a tiny piece of the pie. The following process changes this kind of free social sharing labors by users. On myCountry myWorld, or on a social media platform, users are further rewarded in another competitive setting(s) or method(s) for the purpose of establishing paid social sharers or sharing by social media users. A system is established or employed where users can win and be awarded/rewarded for their selective social sharing. The winners may be multiple, and the awards may be shared between winners. Each month or prescribed time period, a contest will commence where social media users will be required discreetly share the videos, links, promotional product(s), service(s), ad(s), or article(s) of corporations, companies, organizations, or any privately or publicly held entity. Users are to share selectively for example, to share only to the people that they know. Such individual may include a user's family members, schoolmates, coworkers, neighbors, or established friends in or out of a social media platform. Users cannot indiscriminately or randomly share contents with anyone or other users who they do not personally know. Users may include a comment on the content they share to hint the receiver about what is being shared. A set of computer instructions or command will record the amount of social sharing made a user in the user's profile. Each month or descripted period, the system will automatically record the participating users' social sharing in the ranking from the top to the lowest where all users can see how users are in their standing or ranks. At the end of each month, or prescribed period, the top users with the most social sharing are selected and are issued award in the form of cash, coupon(s), gifts item(s) discount(s), saving(s), and/or sales, vacation packages or any other items deemed appropriate. At the end of a given year or preceding 12 months, users with the most recorded and validated social sharing from all the annual winners are selected and issued grand price awards which could be award in the form of cash, coupon(s), gifts item(s) discount(s), saving(s), and/or sales, vacation packages or any other items deemed appropriate. This process is designed to incentivize users to play the role of untraditional or unconventional paid social advertisers/sharers for corporations.

The present invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include smartphones 104a-n, laptop computers 102a-n, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

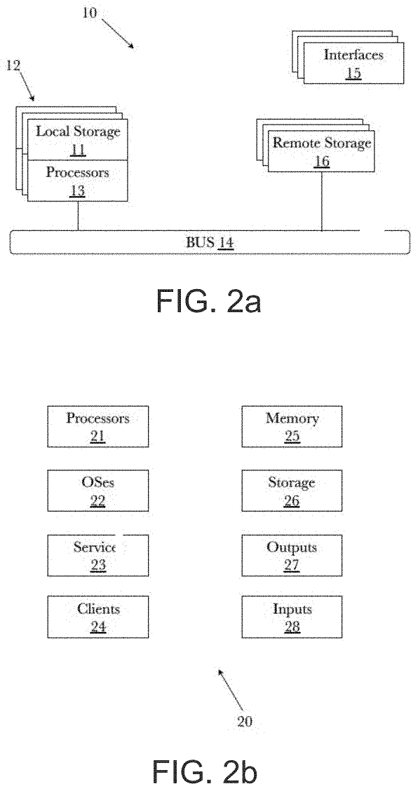

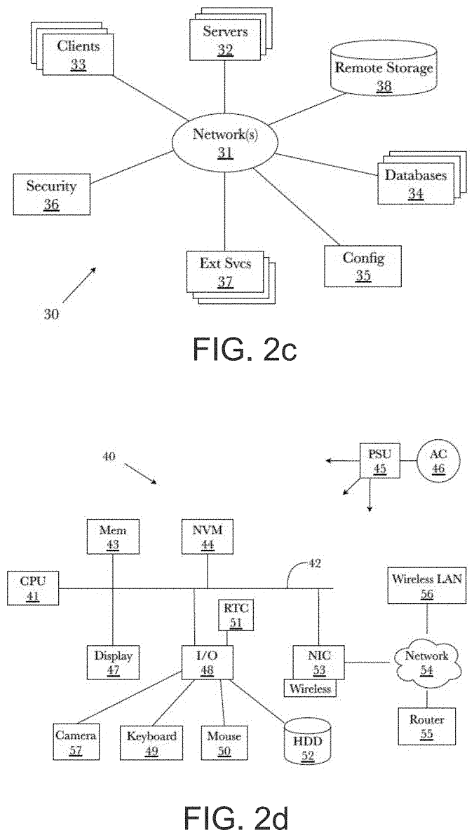

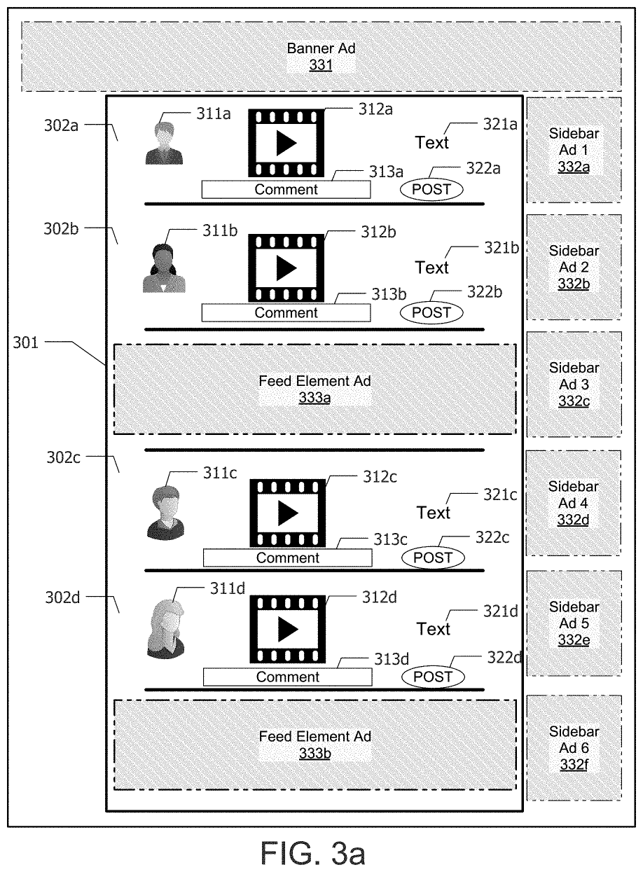

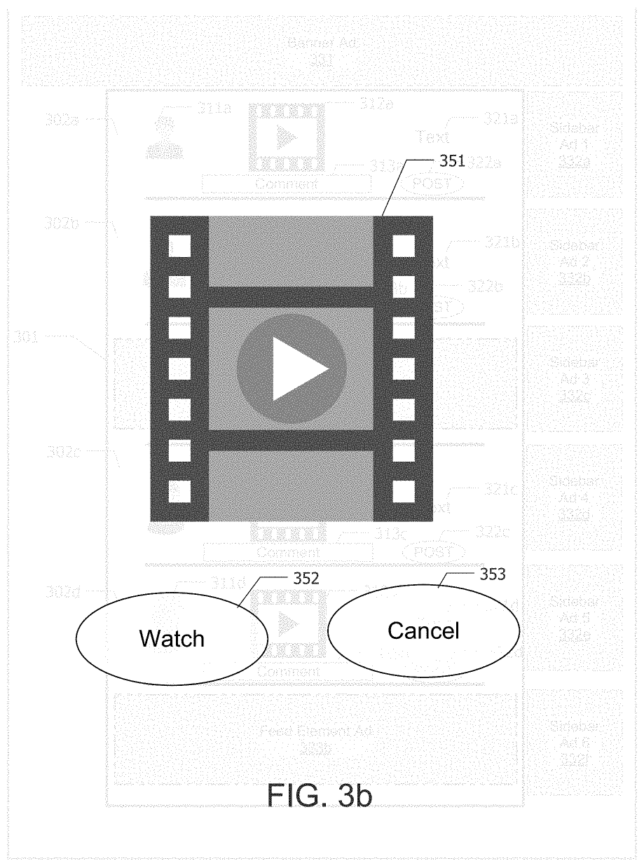

Referring now to FIG. 2a, there is a block diagram depicting an exemplary computing device 10 suitable for implementing at least a portion of the features or functionalities disclosed herein. The computing device 10 may be, for example, any one of the computing machines listed in the previous paragraph, or indeed any other electronic device capable of executing software- or hardware-based instructions according to one or more programs stored in memory. The computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, the computing device 10 includes one or more central processing units (CPU) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random-access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDis), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 21. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in Fig. B. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to a bus 42, to which bus is also connected to memory 43, nonvolatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

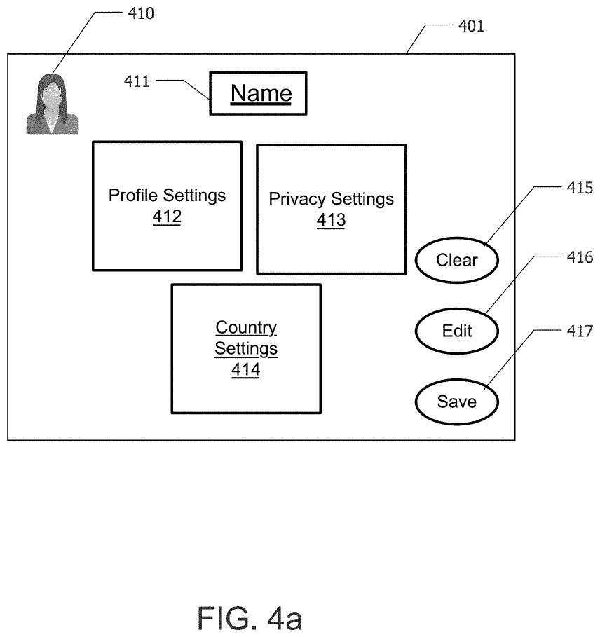

FIGS. 3a-b illustrate an example embodiment of a user feed within a social media system for providing awards and rewards to social media users for the content/posts they upload to their social media profiles according to the present invention. The user feed 301, as shown in FIG. 3a, is a visual presentation of a series of posted content 302a-n that may be scrolled by a user to find content of interest. A viewing user may scroll through the feed to view the content available for viewing. Each of the postings 302a-n has an identifier of a posting user 311a-n, a video clip 312a-n, and a message or caption 321a-n from the posting user. The identifier of the posting user may include a photo, avatar, and a name or ID.

The viewing user may add comments to any particular posting by typing text into a comments entry box 313a-n and submitting the comment for inclusion with the posting. A user control such as a post button 322a-n may be used to submit these comments. A comment may be added at any time and may not require viewing any videos before being able to add the comment.

The user feed 301 also contains a set of advertisements which may include a banner ad 331, a set of sidebar ads 332a-n, and a set of user feed ads 333a-b. These advertisements may be arranged in a manner that causes the user to view the ads while otherwise scrolling through the user feed 301.

Users typically do not like ads especially ads that pop up or require a user to view the ads before viewing an item or video. However, it is a necessary evil since apps developers cannot operate a free website/app and are unable to generate revenue through social media platforms or websites without the ads necessary to generate revenue that enable users not to pay for such services since most social media platforms are free of charge. When a user attempts to watch a particular user video 312b, a pop-up window 350 appears with an ad 351 and two interface buttons: a watch button 352 and a cancel button 353. The user may watch the ad 351 and receive compensation into the user's account and then get to see the selected user video 312. The user may also cancel watching the ad and return to the user's feed 301 of FIG. 3a.

By using the present invention, users may get paid to voluntarily view ads on social media platforms or websites and get a piece of the pie in revenue income received from the ads that are run on content that the user posted. The myCountry myWorld system 100 may reward users for their time to voluntarily and willingly views ads.

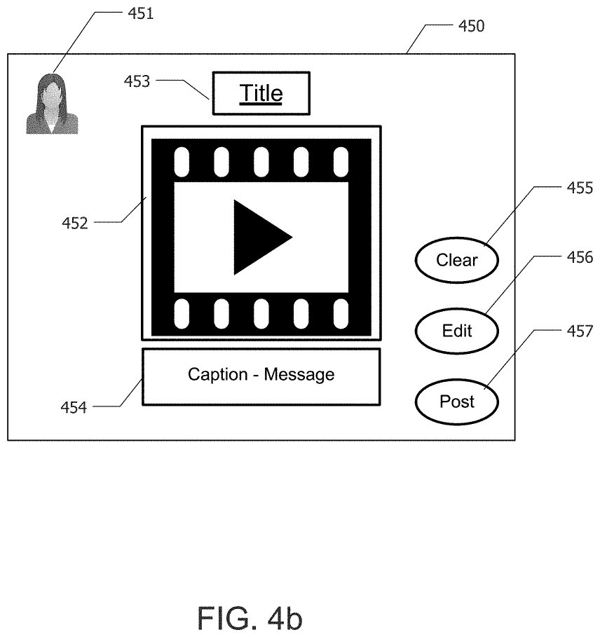

FIGS. 4a-b illustrate an example embodiment of a user profile screen 401 and a user post edit screen 450 within a social media rewards system for providing awards and rewards to social media users for the content/posts they upload to their social media profiles according to the present invention.

After signing up, users can create a customized profile of FIG. 4a revealing information about themselves. They can post text 411, photos 410, and multimedia content which can be shared with any other user that has agreed to be a “friend” or with a different privacy setting, with any viewer/user. Users can receive notifications of their myCountry myWorld friends' activities and the activities of myCountry myWorld users they follow.

The profile page 401 may include a set of profile settings 412 and privacy settings 413 that control how content may be viewed. A user can either opt to limit the upload of content only to their profile page and opt not to upload content on the page that is showcasing content and contests for the platform's general users. In that case only friends or followers that are following a user will be able to see, view, like, or share content or be notified about such content. Additionally, a user can opt to enter or upload content on behalf of his/her country on that page of the platform, using the country settings 414. The country page may showcase content and contests designed only by specific countries.

For example, the world has seen massive viewership in global competitions that inspires talent, i.e. the World Soccer Cup, the Summer and Winter Olympics, and World track & field events. Another example is American Idol and the like. There is, however, no social media system that establishes and inspires similar creative and talent-driven content for social media platforms for titles, awards, and rewards. Videos uploaded on myCountry myWorld 100 may be limited or restricted to short-form or short content videos only and may be limited to a maximum of 3 minutes or less or may increase to more than 3 minutes. MyCountry myWorld is a social media system 100 established to propel and honor excellence in creative content, inspire competitive social media engagement, and foster meaningful connections, awards, and rewards within the creative global community. Annually, the myCountry myWorld Awards system may also select the posts that will win the sought-after Grand Premier, Gold, Silver and Bronze myCountry myWorld Awards and cash rewards. These awards are designed to inspire creative talent for an exclusive and collaborative judging experience by users of the system.

In a preferred embodiment, the odds of matching missing elements in a puzzle and winning may take some effort. For example, typically the odds could be listed as a comparison of numbers: 1:5, 1:10, 1:20, 1:30, 1:40, or 1:50. This means that 1 out of every 5, 10, or 20, or 30, 40, or 50 ads viewed may win a prize.

FIG. 4b illustrates an example embodiment of a user post edit screen within a social media system for providing awards and rewards to social media users for the content/posts they upload to their social media profiles according to the present invention. For each post 450 that a user generates, the post 450 may include a title 453, a multimedia or video clip 452, and a text caption, comment, or message 454. A user likeness or avatar 451 also may be automatically inserted into the posting using an image from the user profile. The user post edit screen 450 includes a plurality of user control elements such as a clear button 455, an edit button 456, and a post button 457 to control the creation, editing, and uploading of the post to the web server 101.

The myCountry myWorld Awards utilizes a model of international awards competition, global showcasing, and social media talents or contents award and reward to push boundaries and establish new precedent in the content that is posted. MyCountry myWorld year-round contests of creativity include a daily users' engagement in posting, viewing, liking, and sharing contents of fellow users on the platform that highlights the best in creativity and top talents in an ever-evolving industry.

When thinking about myCountry myWorld' upload categories think about the following popular TV entertainment shows to put this in perspective or context. Think for example, America's Got Talent. 86% of G-oogle users liked this TV show. Undiscovered talent of all ages that includes singers, dancers, magicians, comics, musicians, ventriloquists and more—appear before celebrity judges who decide which contestants move on in the competition each week. With the guidance of the show's host, the audience learns the backstories of these amazing people as they strive to make it to the finale, where one talented performer wins a life-changing $1 million prize. A select few join the most memorable and extraordinary acts from previous years, along with favorite contestants from other international Got Talent franchises, and return to the stage to show off their talents in hopes of impressing the judges' panel once again and taking home the title of America's “World Champion.”

Also think about American Idol. 80—o of Google users on the other hand liked this TV show. The fun begins with the audition rounds, in which hopefuls from across the country try to wow the judges, who select the most impressive talent from each city. As the competition advances, it is up to the viewers at home to vote for their favorite vocalists in hopes of helping them make it to the next round. In the end, one singer wins the grand prize and is crowned the next “American Idol. Also, think about The Voice. 87% of Google users liked this TV show. The talent and competition are fierce as the game-changing coach lineup goes head-to-head to passionately mentor, inspire and nurture a fresh group of vocal artists from all over the country all of whom come with the dream of being crowned The Voice. Some of the industry's biggest names serve as advisers, offering their professional creative insights and adding to the fun.

Finally think about MTV Cribs (also known as Cribs) which is a documentary television program that originated on MTV and features tours of the private homes of celebrities. MTV currently produces short-form episodes of the program and distributes it through Snapchat Discover. The first show aired in September 2000. MTV Cribs is said to be viewers' one-stop shop for living vicariously through others! In fact, it is said to be the only place where viewers can get a tour of their fav01ite celeb's pad and be jealous of everything they have! The list can go on and on. But what about the average global citizens themselves that may Want to showcase their own cribs, livings, homes, abilities, skills, styles, or talents to entertain others and in this instance, to be awarded or rewarded for their entertaining contents. However, the quest to entertain the public on these networks carrying them are limited to individual TV shows and/or limited to certain participants and audiences, geographical locations, regions or country. B

resides, these TV shows mentioned are seasonal, run only weekly or once a week and can be consistently interrupted by TV commercials. Plus, with the different time zones around the world, it practically impossible to views all these programs even if everyone globally had access to watch the programs. The list of problems goes on. Here, myCountry myWorld's upload categories encompassed all of the above mentioned talent-driven performances under one roof so to speak via a social media platform that will cross all international boundaries, regions, and geographical locations and enable usership and viewership, right in the comfort for the platform's global users and viewers' privately homes, on their handheld mobile phones, smart phones and devices, computers and laptops and provides 24 hours entertainment and judging experiences by the platform's global users.

In a preferred embodiment, categories for uploads include, but are not limited to:
Videos/photos of your personal space or home; your standard of living; your livelihood, your way of life; your achievements, the way of life of people in your country, or your pet.
2) Videos/photos of your personal, traditional, or western styles, dress, fashions, or hairstyles.
3) Videos/photos of funny or humorous contents about you, other people, thing, places or anything in your country.
4) Videos/photos of your history, your culture, attractions or historical attractions, languages, tribes or dialects, wildlife or traditions in your country or videos/photos depicting your country's cities, countryside, beauty, natural wonders, monuments, landmarks, and museums.
5) Videos/photos of individual special talents/abilities, your arts & cultural works, performing arts, music, musicals, songs, singing, short dramas, dance, plays, or singers, dancers, comics, musicians, ventriloquists and more. Any talent including Singers, Musicians, Actors, Novelty Acts, Street Performers. Comedians, Dancers, Rappers.
6) Videos/photos of local, traditional or bazaar foods, gourmet-style presentation of food, or cooking performances.
7) Videos/photos showing or depicting positive happenings, learning institutions in your country, and unique living conditions.
8) Videos/photos of clips from your local sporting events to share with the world.
   The platform will enable the world's people to uncover talent of all ages—singers, dancers, comics, musicians, ventriloquists and more.

Countries Showcasing Category

Part of the social media rewards system I 00 is designed to foster record-breaking global traffic on platforms that will inspire global users' engagement. Users from the same country can team up to form teams or an individual user from any country can upload content to enter a year-round showcasing of places of interests in any country designed for countries only. Any content uploaded by a user or team of users from the same country is credited not to the individual user or team, but to the user or users' country. The posts will show up, for example, as Team USA, Team China or Team Canada based on the country selected during registration or country selected during the upload. Showcasing for countries may run concurrently with showcasing for individual users. The same criteria for the most content views/likes/shares in individual showcasing also applies to country showcasing.

Unlike the individual users' showcasing, however, the showcasing for countries does not award prizes but awards Gold, Silver, and Bronze Certificate Awards. Uploads/content that users can post on behalf of their countries include videos/photos of your history, your culture, attractions or historical attractions, languages, tribes or dialects, wildlife or traditions in your country or videos/photos depicting your country's cities, countryside, beauty, natural wonders, monuments, landmarks, and museums, but are not limited to, the same categories as those listed above for the individual user competition.

The same criteria for the most content views/likes/shares in individual competition also applies to country competition. Unlike the individual users' contest, however, the contest for countries does not award prizes but awards Gold, Silver, and Bronze certificates.

Uploads/content that users can post on behalf of their countries include, but are not limited to, the same categories as those listed above for the individual user competition.

myCountry Incentivize MarketSquare

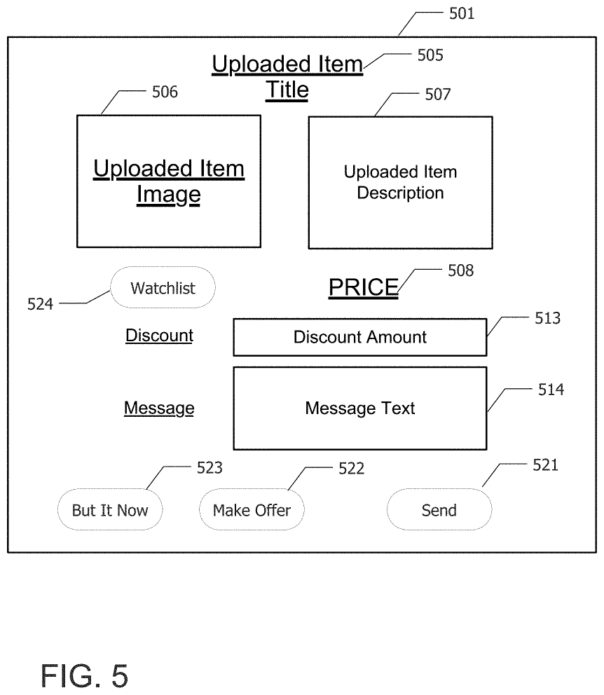

FIG. 5 illustrates an item page 500 from a MarketSquare marketplace for users to buy and sell merchandise to other users according to the present invention. Like Facebook Marketplace, myCountry Incentivize MarketSquare will allow individuals, companies, and brands to sell their products directly without leaving the platform. But there are significant differences and advantages with myCountry Incentivize MarketSquare over Facebook Marketplace.

For example, the demand and competition for users on social media marketplace is daunting and has thus, prompted social media platforms to establish such venues as marketplaces for the selling and buying of goods and services which allows users to sell and buy goods and services on such sites. All this is a strategy and attempts to drive daily active users and traffic on such platforms. More notably, a user on Facebook can open a Facebook Marketplace with photos of items that people near them can see what they have listed and can buy, and vice versa. The user can see a title 505, the photos of items 506, a description of the item 507, and a price 508 that other users near them have listed for sale. To find something specific, a user must search at the top and filter your results by location, category, or price. In interested, the user creates a message to the seller in message text box 514 and sends 521 the seller a direct message from Marketplace to tell them you are interested and make an offer.

However, with the competitive nature of online sales or marketplaces, there is no guarantee that just because a person is a user on a certain social media platform such a user will purchase items sold on such website or platform from fellow users who are also sellers over for example the same item(s) sold elsewhere at different websites or platforms at significantly competitive discounted rates or prices. This presents a problem. Reckoned, there is no competitive advantages or incentivized method or system that these platforms have established or have employed that would otherwise ensure or persuade users to shop from sellers who are fellow users on the platform to which they are also registered users or members themselves. Simply, there is no method, system, or mechanism that would compel users to commit or buy from those sellers who are fellow registered users on the same platforms.

For this reason myCountry myWorld has employed an inventive concept that employs a myCountly Incentivize MarketSquare 500 which is designed to generate more registered and active daily users on a social media platform by creating an incentivize system to aid in the purchasing of goods and services by sellers on social medial platforms, thus, increasing sales for sellers by establishing incentive for buyers, to increase users' traffics and trading on such platform, that would result in increased sales by social media platform's sellers.

For example, a seller must be a registered user of the platform 100 and must commit to select from a range of discount options 513 that the seller is agreeing to offer the platform's general users at signup and/or during item uploads 501 or posting of goods or services. When an item is uploaded or posted, the selected discount 513 that the seller selected at signup or upload is automatically displayed on each item uploaded or posted for sale. Listed discount options are interchangeable and can vary by items. Upon entering a seller's MarketSquare page 501 the seller's selected discount(s) automatically displays to all potential buyers. The seller can update or change the range of discount they selected at signup or upload from a dropdown discount manual/bar to be replaced with different option(s). Examples of options could range from 1) buy one and get one free; 2) buy 2 items and get the 3rd item free; 3) buy one and get 50% off on a second purchase; 4) 5% off, 5) 10% off; 6) 15% off; 7) 20% off; 8) 25% off; 9) 30% off; 10) 40% off; and 11) 45% off etc.

These options give sellers the flexibility they may need to choose an option that is right for them and the items they are selling. A buyer can then call, email, or text the seller and arrange the purchasing of said item(s) at the discounted rate(s) automatically displayed or popup on the seller's page or marketplace. Buyers have other advantageous options or feature to secure an item in the MarketSquare shown below. In so doing, users are rewarded automatic discounts in the buying of goods and services from the platform's sellers; thus, resulting in a win and reward incentive for the platform's registered sellers who are almost guaranteed to continuously and significantly increase their sales, revenues and income from the platform's users who will be hooked and motivated to buy goods and services from the platform's sellers. Buyers on the other hand, are incentivized a guaranteed discounted percentage off the selling price as a reward for being the platform's registered user and buyers.

How it Works

At signup/registration and/or when a user uploads items 501, the user/seller is presented with a batch of discounts 513 options to select. Discounts vary and user/seller can select the discount option that is right for them or the item(s) they are selling. The seller can update or change the range of discount option 513 they selected at signup or from uploading items from a dropdown manual/bar to be replaced with a different discount option.

The option selected by a user/seller appears on the seller' myCountry Incentivize MarketSquare page 501 where a buyer can see upon entering the seller's MarketSquare. The sale price 508 is also shown, and a buyer can calculate the offered discount from the sale price.

myMessage is a click or check button 521 feature on the marketplace page and is the platform's communication medium that enables users/buyers to message 513 a seller to make inquiries about a product the seller posted. The message goes into the seller's inbox in the seller's Private Dashboard. A user/buyer can click the myMessage button to send a message to the intended recipient(s). In any case, users/buyers are to communicate with and contact sellers to discuss and complete all transactions of interests.

Make Offer is a click or check button 522 feature on the marketplace page that enables users/buyers to speedily make an offer about a product they spotted that they desperately want. In this case, a user/buyer can option to offer more or less for the item that give the user/buyer an advantage or first standing over other users/buyers that also desperately want the item. It provides an incentive for the seller(s) to sell the item to the highest bidder. The more the offer the better chances that the seller will sell the item to the buyer. In any case, users/buyers are to communicate with and contact sellers to discuss and complete all transactions.

Buy It Now is a click or check button 523 feature on the marketplace page that enables users/buyers to speedily buy an item that they spotted and want to be the first to buy. Sellers are alerted of the user/buyer's reservation on the item. Buying an item is based on a first to buy first to have basis. However, if another user does not click the buy now button 523 but clicks the make an offer button and that offer the user/buyers makes is higher than the sale price, the seller may choose to sell to the user/seller with the higher bid. If a user/buyer clicks the buy now button, and is first in line, the user/buyer is given preference on the item by the seller over all other users/buyers who do not make higher bids, and must contact the seller and is obligated to pay for the item. In any case, users/buyers are to communicate with and contact sellers to discuss and complete all transactions.

Add to Watchlist is a click or check button 524 feature on the marketplace page and a button that enables users/buyers to add certain items that they want to track to their watchlist in their History, or Activity on the user's Dashboard to buy later. In any case, users/buyers are to communicate with and contact sellers to discuss and complete all transactions.

Picture a scenario where users of myCountry myWorld are presented with the option to buy from Facebook marketplace and Instagram marketplace where they are also registered users on those platforms. Because of the inventive concept or business model employed on myCountry Incentivize MarketSquare, items or services are uploaded to reflect the specific discount(s) that a seller selected at signup or upload. Consider that identical or similar items that are for sale on myCountry MarketSquare are also for sale elsewhere including on Facebook Marketplace, Instagram Marketplace where buyers are also users.

The items or services that are for sale on all platforms (myCountry Incentivize MarketSquare, Facebook Marketplace, Instagram Checkout and on other websites) are being sold for the same price or for similar prices or being sold for different prices. However, because such platforms do not employ a system or model that requires the system to present a seller with a list of discount options to select at upload that would then automatically display the discount(s) selected to a buyer seeking to buy on the seller's store as is employed on myCountry Incentivize MarketSquare, users will be most likely buy from the platform which business model is display guaranteed discounts to its buyers, offered by its sellers on all items and services sold on its platform. Because of this business model employed on myCountry Incentivize MarketSquare, sellers are to hold a competitive sales edge or advantage over sellers on Facebook Marketplace, Instagram Checkout, or other social media platforms and websites.

According to study, about 93% of shoppers use coupons and/or discount codes throughout the year. It shows that the vast majority of consumers are seeking good deals since everyone appreciates good deals. For example, sellers can sell up to 73% more if they offer a bonus pack. One study even showed a 73% increase in the sale of items in a value pack. Consumers opted for the larger quantity over the other option, which was a reduced priced for a reduced quantity. Studies show that 30% of people purchase to gain something. Statistics have shown that marketing messages affect buying behaviors globally. A study finds that in the quest for discounts, seven out of ten people reported using an emailed discount in the previous week. This statistic proves that, regardless of the varying opinions out there, consumers are receptive to discounts. For example, 75% of consumers report scouring their inboxes just to look for relevant discounts. 55% of consumers receptive to email marketing prefer money-off deals. Even more popular than free shipping and loyalty rewards, consumers want a price deduction before anything else. This means that consumers are drawn to a price reduction and are four to five times more likely to make a purchase if offered discounts. The conclusion here is that discounts drive marketing anywhere and everywhere. Hence, it is imperative that such business model or system that automatically offers users discounts via social media platform or employed on a social media marketplace is required and needed for the purpose of increasing the sales of goods and services for users/sellers and rewarding users/buyers via social media platform.

Color-Coded Rating and Alert System.

When a user uploads a post or content, it will show a green color-coded status. Plus, the post or content will display the user's name, state and country of birth or resident. A green color-coded status indicates that a content or post is competing for the platform's Global Showcasing Award and Reward and has gained entry on the platform's global showcasing feed. Computer coded programs or instructions employ certain milestones that must be reached by each content or post to experience changes or transformation from one color to another based on the amount of views, likes and shares of a post or content. Displaying or appearing with a green-color lining, a post or content must reach for example, 50,000 views, 25,000 likes, and 15,000 shares to change from green-color lining to an orange-color lining. Any user that reaches said required milestones, will see their post or content automatically transform from green lining/layer to orange lining/coating.

Displaying an orange-color lining or layer, a post or content is presented with new milestones and for example, must reach 75,000 views, 50,000 likes, and 25,000 shares to change from orange-color lining or layer to red-color lining or layer. At this juncture, stage or point of a red-color lining or layer, all users that reach the combined milestones of 100,000 views, 75,000 likes, and 50,000 shares, will see their posts or contents automatically transferred into a new feed called the Finalists' Feed. The Finalists' Feed is a page on the platform where users can cast their vote for what each user individually believes is the best post or content and that User's Choice for best post/content that made entry into the contest on the platform. To vote, users will check or click the vote button on a post or content.

As users cast their votes, posts and contents will begin to form ranks or standing by recorded votes per post or content as all posts are automatically placed in the ranks or standing of number 1, 3, 4, 5, and so forth, positions in their ranking. At the end of each competition the top-ranking posts or contents are selected as the winners beginning with the I st place, 2nd, 3rd, and 4th runner-up. The total number of winners that follow the winners with the top four spots are determinative from competition to competition and year to year. Contests are to run on the platform once a year, twice a year or multiple times per year.

The milestones described herein are only for the purpose of illustrations. Required milestones may be adjusted accordingly, from year to year based on the increase of users' traffic on the platform. Note that colors are not limited to green, orange, and red and may change or apply to any known color. Methods and rating of users' posts or contents may vary or change and are not limited to the methods described herein.

myCountry myWorld Live Stream

Users can go live on social media platforms to broadcast a conversation, performance, Q&A or virtual event. You can go live on a Page, in a group or an event, and your live videos will also appear in people's News Feed. Social media platform(s) has proposed giving live streaming users for performing arts and other industries affected by the coronavirus pandemic the option to charge other users for access to their live-streamed videos. For example, if a user chooses to use a social media platform, the user must pay for free access to the social network by letting it show that user ads. That is the extend of a user's benefit, incentive, or reward. Although many social media users feel that it is about time that they started to get something back from such sites or platforms for their creative contents, they get nothing in return and are not offered a piece of the pie from advertising revenue. Some social media platform may give live streaming users the option to charge other users for access to their live-streamed videos. But this does nothing to temporarily or permanently solve this problem or resolve users desires to compete for a price, awards, rewards or for a piece of the pie. Whether short or long term, contents of social media platforms should be free across the board given that the bargain presented to users is unfair and unbalanced-to the extent that it requires social media users to agree to be subject to ads and join for free. Without users' interactions, engagements, creative contents and users' willingness to share their creative, talent-driven contents for free-without any rewards, all in the name of free membership or usership to social media platforms and agree to be bombarded with ads that creates adverting revenues that are limited to the owners of social platforms, does little to create incentive to users that will foster global competition that could lead to discoveries and inspire talent-driven contents that entertain social media viewership. There is no incentive in taxing social media users, thus, requiring users to pay before they can watch their favorite live streaming programs or shows. Such is a burden, presents a problem and puts certain users at a disadvantage since most global social media users around the world are inherently poor, and may not be able to afford to pay for their favorite live streaming shows or programs that requires users to pay before gaining access an may be deprived of such live streaming shows or programs. For many social media users this may the equivalent of what could be called a social media tax which is a problem. The present invention provides a solution to reward live streaming users for their work in the form of fair contests or competitions.

MyCountry myWorld users can live stream in an online streaming media which may be simultaneously recorded and broadcast in real time for a defined period to be established by the platform. Users that live stream their programs are to compete in a live streaming category competition where they are rated or judged based on their live streaming viewership or audiences during each live streaming segment. For example, the platform employs a method where each live streaming segment will automatically capture and record the total number of viewership per segment each time that a user live streams during the duration of each competition set by the social media platform. After the end of the duration of each competition, the system employs a method that automatically averages a user's average viewership for the duration of when their live streaming shows or programs began and ended each time that they live stream through the end of said competition prescribed by a social media platform. The users that live stream during the duration of the competition with the highest average viewership will win awards and rewards and are to be issued certificate or trophy awards and/or cash rewards or other awards or rewards. As with users' live streaming awards, awards may be certificates or trophy or any other awards for every category of talents on a social media platform or more specifically, myCountry myWorld. Live Stream international awards competition, and social media talents or contents competition may join to participate in a global award ceremony or show to be hosted annually by a social media platform or more specifically, myCountry myWorld.

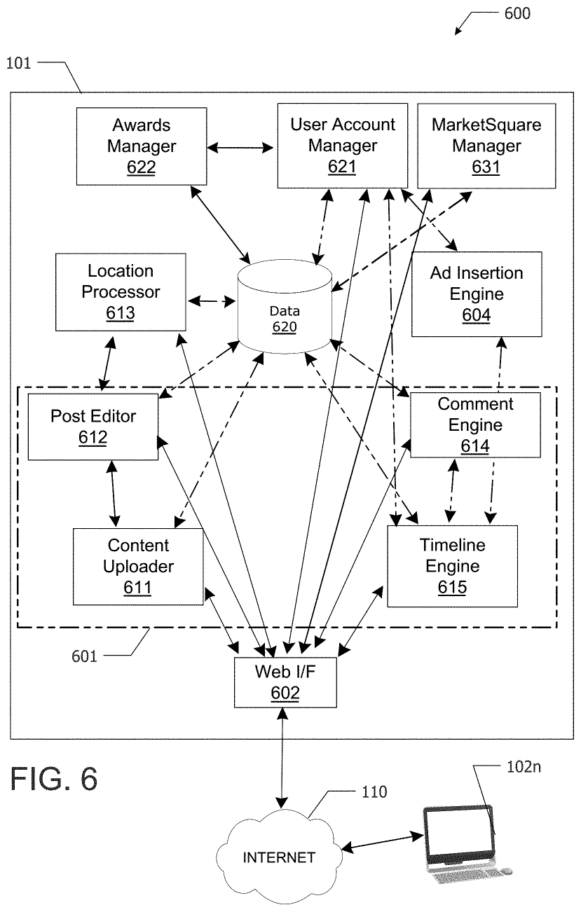

FIG. 6 illustrates a computing system 600 of software components for providing awards and rewards to social media users for the content/posts they upload to their social media profiles according to the present invention. The social media rewards system 600 is hosted on a web server 101 and comprises a set of processing elements that perform its functions. These processing elements include a timeline engine 601, a web interface 602, a comments engine 603, an ad insertion engine 604, a content uploader 611, a post editor 612, a location processor 613, a user account manager 621, an awards manager 622, and MarketSquare Manager 631. A server data store 620 maintains all of the user profiles, posts, advertisements, and awards data used by all of the various processing elements.

The timeline engine 601 generates a viewing user feed containing posted content of users as well as various ads. The timeline engine 601 uses the user profile settings 412 and the privacy settings 413 of the users 100 to determine if a particular posting should be included within another user's feed. The timeline engine 601 also interacts with the comments' engine 603, the ad insertion engine 604, and the location processor 513 to generate the content used in the user feeds 601. The timeline engine 601 receives information about the users from the user account manager 621 to create a user feed 301 tailored to individual viewing users.

The web interface 602 permits the web server 101 to communicate with remote user computing devices 102a-n, 105a-n and mobile devices 104a-n. The web interface performs all of the data formatting, computer to computer communications, encryption processing, and all similar operations needed by the web server to communicate with users.

The comments engine 603 receives comments to be added to a post from users via the web interface 602 and adds them into the post data structure stored on the data store 620. The comments engine 603 also provides any comments needed for inclusion in a user feed 301 that is generated by the timeline engine 601.

The ad insertion engine 604 generates the ads to be inserted into a user's feed page 301 and the banner ads 331, the sidebar ads 332, and the user feed ads 333 sent to a user. The ads are stored and retrieved from the data store 620 or links to ads from other web sources that the ad insertion engine 604 includes in the web content sent to a user as part of the user feed 301. The ad insertion engine 604 also keeps track of the number of ads and the identity of the ads that a particular user watches. This recordation of the ads watched is provided to the user account manager 621 to permit any awards that may be granted to the user or any fees to be paid to the user because of the number of ads watched.

The content uploader 611 receives the content of a post submitted by a user. The content uploader 611 interacts with the post editor 612 as the user is creating, modifying, and deleting a post. All of the content within a post is captured by the content uploader and formatted and stored into the data store 620 for use by the timeline engine 601 to use the post when creating a user feed 301. The content uploader 611 may also check to see if the content being submitted is provided in a particular data format, to see if the content meets standards for obscenity or offensive content, and to see if the content includes possible copyright infringement or other legal requirements. The content uploader 611 may either reject the upload data from a user or attempt to convert the data into a proper format before it is stored into the data store 620. Uploaded data should be converted as needed at the time of upload before it is included in user feeds 301 by the timeline engine 601.

The post editor 612 interacts with a user via the web interface 602 to provide a template for creating and editing a post, to define the content, both text and multimedia data, for a post, and to provide any needed support for the content uploader 611 to receive a post for insertion into the datastore 620. The post editor 612 interacts with the user either by communicating with a native or mobile application or by communicating with a web browser, where the post editor 612 providing the data needed by the user's method of interaction with the social media platform 100.

The location processor 613 is used to tag any uploaded content with location or country data needed to support the country categories of data used in awards and related competitions. The location processor 613 may obtain location information from geotagged metadata that is part of any images and videos being uploaded. The location processor 613 may also obtain the location data from the post editor 612 which may query the uploading user's application or web browser for location data of the user at the time of the upload action that may be available from the computing device used by a user.

The user account manager 621 permits users to create an account, set profile 412 and privacy settings 413, and all related preferences 100 when processing data to and from the user. The user account manager 621 performs the authentication and authorization processing needed for an individual user to log into the web server and provide the authenticated identity information to other processing elements as needed when content is uploaded and a user feed 301 is generated.

The account manager also receives ad watching data from the ad insertion engine 604 for use in determining awards and payments to the user for their online activities. The account manager 621 also tracks the number of views a user post has generated when the timeline engine 601 is asked to provide streaming data associated with the post to a viewing user. All of the user account data is stored within the datastore 620 as it is generated.

The awards manager 622 uses user account data from the data store 620 to determine which users and individual posts are to receive the various awards and payments based upon a particular user's content. The awards manager 622 may receive input from content judges who may provide identities of particular posts for calculating any awards to be granted.

The MarketSquare manager 631 allows sellers to list items for sale to buyers on the platform 100 as discussed above in reference to FIG. 5. Buyers are able to view the buyer's page 501 to review a photo 506 and description 507 for the item. Buyers may compose a text message 514 to be sent 521 to the seller, or may immediately make and offer 522 or attempt to but it now 523. The MarketSquare Manager 631 processes the creation of the item pages 501 and stores them onto the datastore 620. The MarketSquare Manager 631 also processes all messages and sale communication between buyers and sellers provided on the item page. The MarketSquare Manager 631 maintains a watchlist 524 for each buyer of items that he/she may have an interest as well as permit the buyers to retrieve, view, and manage their watchlist 524.

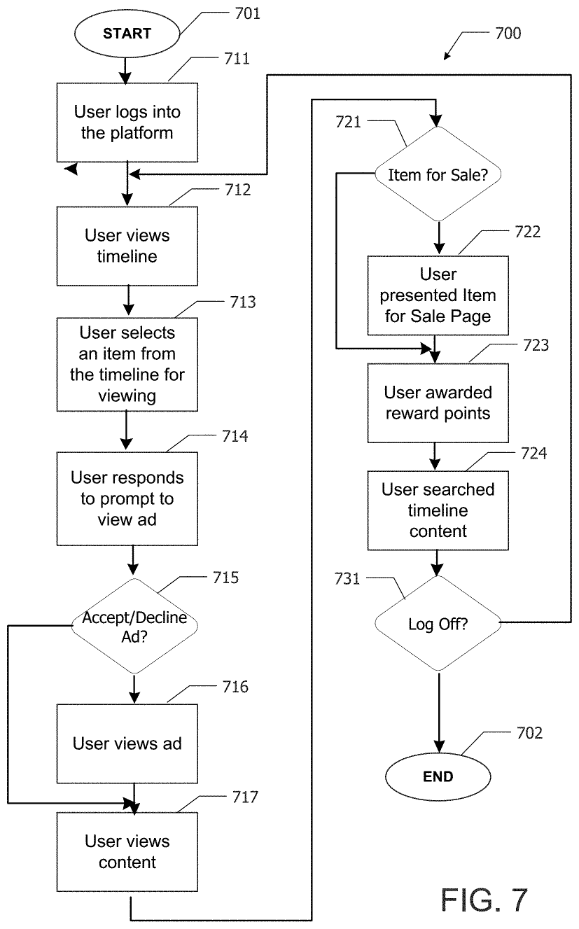

FIG. 7 illustrates a flowchart corresponding to a method performed by software components for providing awards and rewards to social media users for the content/posts they upload to their social media profiles according to the present invention. The method 700 begins 701 when in step 711 a user logs into an online platform. In step 712, the user views a user timeline containing a sequence of posted content, comments, items for sale, and ads associated with each of the social media users, the user timeline includes content showcasing competitions.

The user selects in step 713 a first posting from the user timeline for viewing. The platform prompts the user to view an ad before viewing the first posting in step 714. Test step 715 determines whether the user accepts or declines the ad. When the user accepts the ad, step 716 shows the user the ad before streaming the content in exchange for reward points. When the user declines the ad, the user is immediately shown the content in step 717.

Test step 721 determines whether the item selected in step 713 is an item for sale. When the user selects an item for sale from the user timeline, step 722 presents an item page associated with the item for sale. Step 723 awards reward points to the user in response to content showcasing competition awards. Step 724 assists the user in searching the platform for additional user timeline items for viewing. The process continues until step 731 determines when the user logs off, when the process ends 702; otherwise the process returns to step 712.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

What is claimed:

1. A system for providing a social media platform, and more specifically, a system for providing awards and rewards to social media users for the content/posts and items bought and sold, the system comprises:
a content management manager for creating, managing, and displaying a user timeline for each of the social media users;
an ad insertion engine for creating, managing, and inserting ads into the user timeline for each of the social media users;
an awards manager for awarding each of the social media users rewards in exchange for watching ads before viewing content; and
a marketsquare manager for creating, managing, and displaying items for sale in an online marketplace in which each of the social media users may be buyers and seller.

2. The system according to claim 1, wherein the content management manager comprises:
a timeline engine for generating the user timeline containing posted content of users as well as various ads;
a comments engine for receiving and storing comments to be added to a particular post;
a content uploader for receiving the content of posts submitted by a user;
a post editor for creating and editing a post, to define the content, both text and multimedia data, for a post.

3. The system according to claim 2, wherein the ad insertion manager further generates ads to be inserted into the user timeline and the ads sent to a user.

4. The system according to claim 2, wherein the awards manager further determines which users and individual posts are to receive the various awards and payments based upon particular content contained therein.

5. The system according to claim 2, wherein the marketsquare manager further processes the creation of the item pages;
processes all messages and sale communication between buyers and sellers provided on the item page; and
maintains a watchlist for each buyer of items selected when viewing an item page.

6. The system according to claim 2, wherein system further comprises:
a user account manager for creating an account, setting profile and privacy settings, and preferences used when processing data to and from the user; and
a location manager for tagging uploaded content with a location data needed to support the country categories of data used in awards and related competitions; and
a datastore for maintain user data, timeline data, marketplace data, and awards data used by the system.

7. A method for providing awards and rewards to social media users for the content/posts they upload to their social media profiles, the method comprising:
logging a user into an online platform, the platform comprising:
a content management manager for creating, managing, and displaying a user timeline for each of the social media users;
an ad insertion engine for creating, managing, and inserting ads into the user timeline for each of the social media users;
an awards manager for awarding each of the social media users rewards in exchange for watching ads before viewing content; and
a marketsquare manager for creating, managing, and displaying items for sale in an online marketplace in which each of the social media users may be buyers and seller.
viewing the user timeline containing a sequence of posted content, comments, items for sale, and ads associated with each of the social media users, the user timeline includes content showcasing competitions;
selecting a first posting from the user timeline for viewing;
prompting the user to view an ad before viewing the first posting;
when the user accepts the ad, the user is shown the ad before viewing the content in exchange for reward points;
when the user declines the ad, the user is shown the content;
when the user selects an item for sale from the user timeline, presenting an item page associated with the item for sale;
awarding reward points to the user in response to content showcasing competition awards; and
searching the platform for additional user timeline items for viewing.

8. The method according to claim 7, wherein the marketsquare manager permits the user to:
view an item page containing a first item for sale, the item page comprises a title, an image, a description, a discount and a listed price;
send messages to a seller of the first item for sale;
send an offer to the seller containing a user offer price for the first item for sale;
send a buy it now request at a listed price on the item page on to the buyer to purchase the first item for sale; and
applying a seller discount listed on the item page to the listed price when completing sale of the first item for sale.

9. The method according to claim 7, wherein the method further comprises:
uploading content to the platform for inclusion onto one or more of the user timelines, the content comprises photos, user-made videos and items for sale.

10. The method according to claim 9, wherein photos that showcase users' traditional and western styles, dress, fashions, and stylish-hairstyles.

11. The method according to claim 9, wherein the user-made videos showcase users' talents, homes, living or things and places of interests in users' countries.

12. The method according to claim 7, wherein viewing an ad before view content comprises:
playing an ad to the user for view;
presenting the user with a trivia quiz at the end of an ad on a social media platform and website in which reward points may be received; and presenting the content to the user; and
presenting the user with a treasure hunt and clue at the end of an ad on a social media platform or web in which reward points may be received; and presenting the content to the user.

13. The method according to claim 7, wherein the method further comprises:
organizing content items posted by users according to viewable category timelines viewable by users;
providing the each of the social media users access to the viewable category timelines; and
displaying the viewable category timelines when selected by one of the social media users.

14. The method according to claim 13, wherein the viewable category timelines are organized by a country of origin associated with each of the social media users.

15. The method according to claim 14, the method further comprises awarding each of the social media users reward points that posted content that was listed on a viewable category timeline selected as a winning country associated with uploaded content during a defined period of time.

16. A method for providing a system-generated dropdown menu, the system configured to communicatively interconnect a social media platform and one or more client devices, the method comprising:
displaying a list of discount options to sellers to employ; and
displaying said discount sale options in a social media marketplace to social media buyers on the seller's social media marketplace on the items sold.

17. A non-transitory computer-readable recording medium in a system for providing social media platform, the system configured to communicatively interconnect a social media platform and one or more client devices, the non-transitory computer-readable recording medium storing one or more programs which when executed by a network controller of the gateway device performs steps comprising:
displaying a color-coded display alert and/or rating system that will enable a user's post/content that reaches certain prescribed milestones to change from one color to another on a social media platform;
providing a social media platform rating system that alerts users of the tenure, duration and rating of milestones reaching in an amount of content views, likes, and shares on a social media platform after a user uploads a post; and
sending notifications to users when transformation or changes in rating or color-coded status occurs to their posts.

18. The non-transitory computer-readable recording medium according to claim 17, wherein the method further comprising:
displaying social media users ranking by their posts from a voting process among social media users on the social media platform according to the social media user rating when selecting a particular post that a social media user thinks is the best posts.

19. The non-transitory computer-readable recording medium according to claim 17, wherein the method further comprising:
assigning credit to a user for the user's social media posts with a display of user's name, the user's location, and the user's country of origin associated with, the user's social media posts even when such posts are shared by other users on the platform.

20. A method for incentivizing by awarding or rewarding a social media user's social sharing on social media platform for the number of social sharing that the user made, the method comprising:
enabling the social media user to accumulate a recorded number of shared posts or contents each time that the user shares a post/content;
establishing an incentivize residual reward structure or system for social sharing, wherein after an initial social sharing is initiated by the social media user, all subsequent social sharing of the same post by other users accrue the recorded number of social sharing and genealogy from the last social sharers to subsequent sharers down to the original social sharer. Each user's recorded number of shares in the social media user's profile increases per shares;
establishing an amount of shares posts and contents on the social media platform receive from the social sharing of the social media user's post by other users that can be awarded; and
rewarding the social media user for the user's number of social sharing the social media user individually made and the social sharing of a social media user's post by other users.
